(19) United States
(12) Patent Application Publication
(10) Pub. No.: US 2021/0094516 A1
(43) Pub. Date: Apr. 1, 2021

(54) AUTOMOTIVE SUNROOF/MOONROOF DRAIN CLEANER

(71) Applicant: Mohsen Zolghadr, North Haledon, NJ (US)

(72) Inventor: Mohsen Zolghadr, North Haledon, NJ (US)

(21) Appl. No.: 16/587,216

(22) Filed: Sep. 30, 2019

(51) Int. Cl. B60S 3/04; B08B 9/032; B60J 7/00

(52) U.S. Cl. CPC B60S 3/044; B08B 2209/032; B60J 7/0084; B08B 9/0321

(57) ABSTRACT

A sunroof drain cleaning apparatus and method are provided that include an injector for providing pressurized cleaning fluid to a tube, a tube for providing localized and pressurized cleaning fluid to said sunroof drain, where the cleaning fluid is pressurized, and where the cleaning fluid is a solvent. Further, a method for cleaning a sunroof drain includes locating one or more sunroof drains, removing any large debris from the drain opening, filling a sunroof drain injector with solvent to unclog the drain, pressurizing the solvent within the injector, applying the pressurized solvent into the sunroof drain; and optionally pouring water into the drain to test that the clog has been removed.

### FIELD OF THE INVENTION

The present invention relates generally to a device for clearing or stripping debris and other matter from a flexible tube. In particular the invention relates to a device that is easily usable to clear a sunroof/moonroof (“Sunroof”) drain in a vehicle through the use of a directed solvent and directed pressure.

### BACKGROUND OF THE INVENTION

In general, a sunroof in the roof panel of a vehicle is provided for ventilation of the inside of the vehicle by opening a portion of the roof panel. That is, a sunroof is provided to allow more external air to flow into a vehicle when the inside of the vehicle is ventilated. A sunroof is composed of a frame disposed at the edge of an opening formed through a roof panel, a glass being movable inside the frame, and a sunshade slidably disposed under the glass.

A drain structure is used for discharging rainwater that flows into a gap between a roof panel and a sunroof when it rains That is, in order to prevent rainwater from flowing into a sunroof, in the related art, there is a configuration that guides rainwater into the outer rail of a guide rail and discharges the rainwater outside a vehicle through a drain channel. However, when rainwater over the capacity of the outer rail flows into the outer rail of the guide rail, the rainwater may flow into the inner rail or into the vehicle. Accordingly, the head lining in the vehicle may be contaminated or other parts may be corroded.

Sunroof/Moonroof drains are an aspect of your car that one probably rarely, if ever, think about. Though the sunroof is sealed to keep most moisture out, some moisture and water does come in through the gap between the sunroof and the car itself. The moisture is then drained out of the vehicle through the sunroof drains, which run from inside the roof area and exit somewhere else. If the drains become clogged, it can make your interior smell musty and eventually create major problems with the sunroof and other electrical components that come in contact with the moisture. Your car's sunroof drains should be cleaned regularly.

The Prior art drain cleaning systems and methods are well known and are related to snakes and other similar ways to physically remove a clog from a drain. However, none of these techniques address the problem of dissolving debris from clogged drains using a solvent and pressure that are not harmful to a vehicle's paint and the vehicle's delicate drain tubing that are aspects that must be considered with attempting to clean the drains of a sunroof.

### SUMMARY OF THE INVENTION

Embodiments of the present invention relate to apparatus and methods that may be used to clean a clogged drain from a sunroof.

In one aspect, a sunroof drain cleaning apparatus may include an injector for providing pressurized cleaning solvent to a tube; a tube for providing localized and pressurized cleaning solvent to a drain; and a means for pressurizing the cleaning solvent.

In another embodiment, a method for cleaning a sunroof drain may include locating one or more sunroof drains; removing any large debris from the drain opening; filling a sunroof drain injector with solvent to unclog the drain; pressurizing the solvent within the injector; applying the pressurized solvent into the sunroof drain; and optionally pouring water into the drain to test that the clog has been removed. The cycle may be repeated.

In yet another embodiment, sunroof drain cleaning apparatus comprising means for injecting a cleaning fluid into said sunroof drain.

In still yet another embodiment, a method for cleaning a sunroof drain comprising the steps of: utilizing a cleaning fluid for cleaning said sunroof drain; and injecting said cleaning fluid into said sunroof drain; wherein said cleaning fluid is a solvent; wherein the step of injecting further comprises the step of utilizing a tube for delivering said cleaning fluid into said drain.

In yet another embodiment, a method for cleaning a sunroof drain comprising the steps of removing any large debris from the drain opening; applying the pressurized cleaning fluid into said sunroof drain; and pouring water into the drain to test that any clog has been removed.

Additional aspects of this disclosure are directed to methods for manufacturing and methods for employing any of the herein depicted or described vehicle sunroof drain cleaning apparatuses. The representative apparatuses and methods include, in any order and in any combination with any of the disclosed features and options.

The above summary is not intended to represent every embodiment or every aspect of the present disclosure. Rather, the foregoing summary merely provides an exemplification of some of the novel concepts and features set forth herein.

### BRIEF DESCRIPTION OF THE DRAWINGS

FIG. 1 shows a typical sunroof 100 and FIG. 2 shows a typical drain hole 210. A plurality of drain holes 210 may be located within track 116 of sunroof 100. Drain holes 210 may be located anywhere along track 116, however drain holes 210 are typically located towards the front and rear of a vehicle.

FIG. 3 shows a typical sunroof with drains 310 that may become clogged with organic and inorganic debris. FIG. 3 also shows that drain hole 210 may be connected to drains 310 and that there may be a plurality of drain holes 210 and drains 310 along track 116.

FIGS. 4, 5, and 6 show drain cleaner 400. Drain cleaner 400 may include cleaning fluid holder 410, plunger 430, plunger handle 440, injector rod 450, reducer 460, and application rod sections 470 and 480. The drain cleaner 400 shown in FIGS. 4, 5, and 6 may also be referred to as an injector 400.

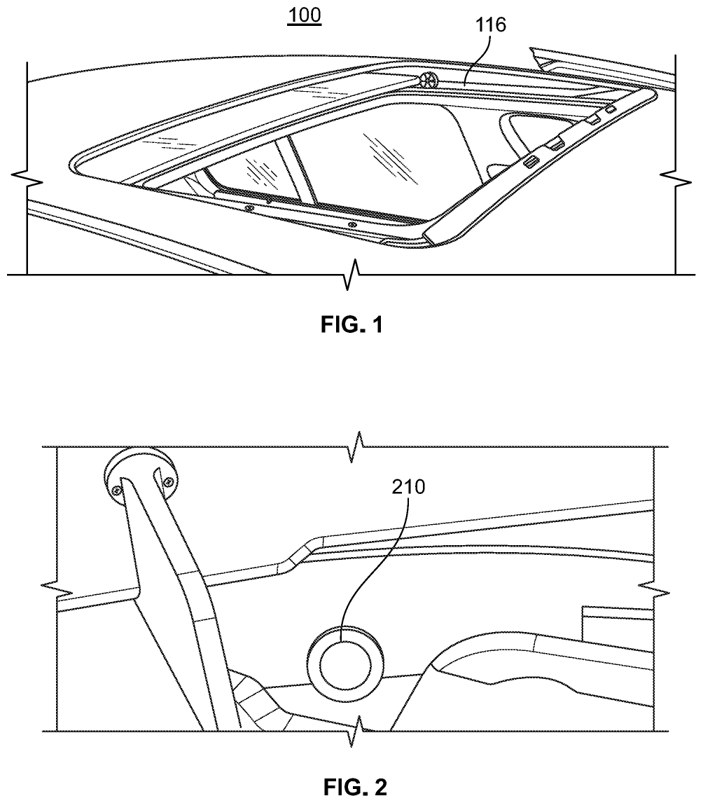

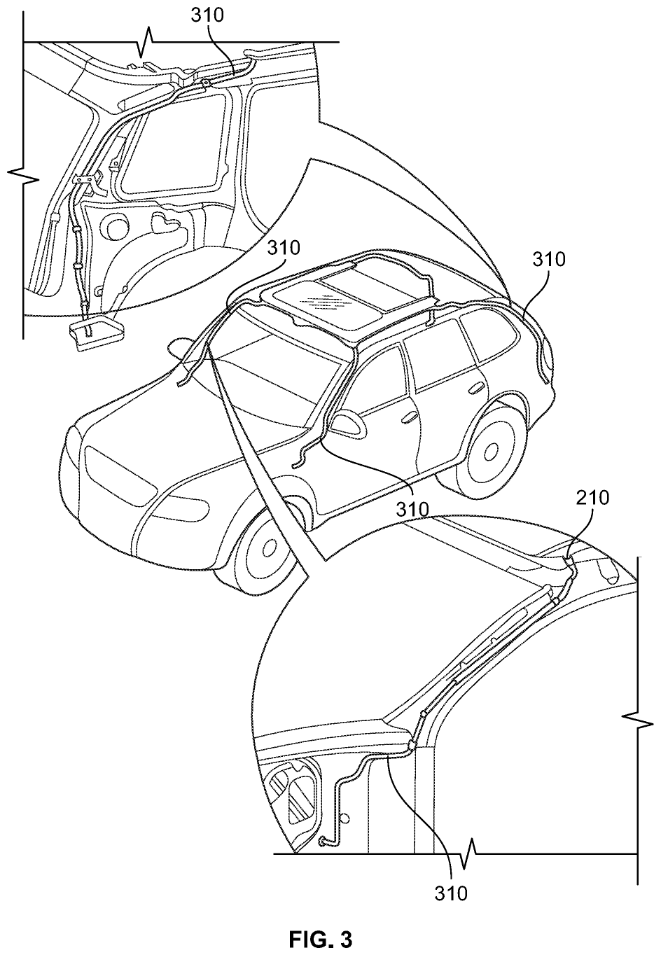

As previously stated drain cleaner or injector assembly 400 may include cleaning fluid holder 410, plunger 430, plunger handle 440, injector rod 450, reducer 460. Cleaning fluid holder may be any container to allow for the containment of fluid of various viscosities. For example, cleaning fluid holder 410 as shown may be a clear plastic or glass container but may be any size or shaped container that will hold fluid in a pressurized state.

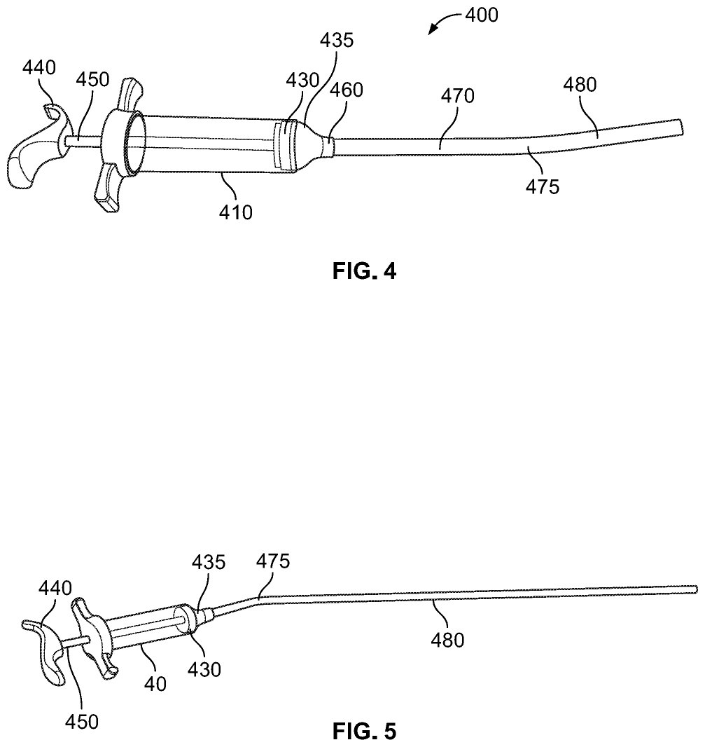

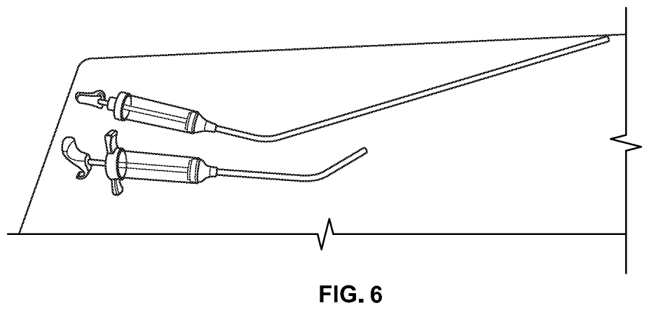

Additionally, injector assembly 400 may include plunger 430, plunger handle 440, and injector rod 450. Plunger 430, plunger handle 440, injector rod 450 may work in conjunction with each other to create pressurization within the cleaning fluid contained within cleaning fluid holder 410. In the present embodiment, the injector assembly is much like a needle that creates pressure when plunger 430 is in a retracted position. FIGS. 4, 5, and 6 show the plunger in an extended position. As a user pushes on plunger handle 440, air within cleaning fluid holder 410 creates pressure on the fluid within cleaning fluid holder 410 and pressure is further exerted on the fluid when the fluid passes through reducer 460. One skilled in the art will appreciate that the injector assembly 400 may be modified in such a way to allow for the buildup of pressure by a screwing motion, a pumping motion, or any other suitable means of generating pressure on a fluid. Other exemplarily means may include using a CO2 cartridge that pressurizes the fluid within cleaning fluid holder 410.

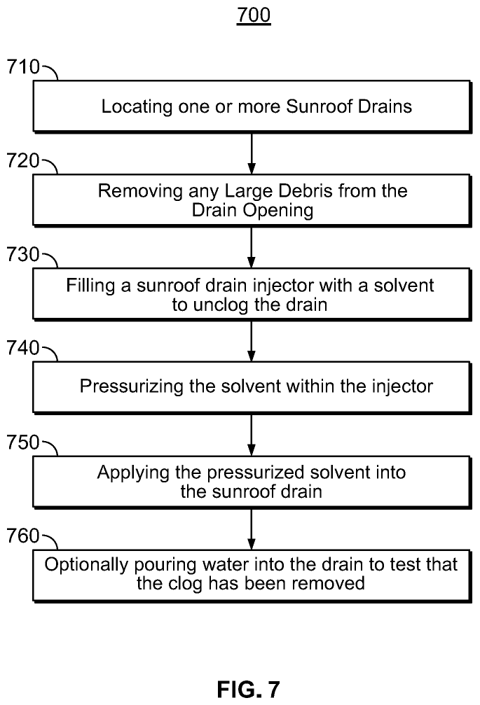

As shown in FIG. 6, application rod sections 470 and 480 may be various lengths with to accommodate various locations of drain holes 210. Additionally, Along the length of application rod sections 470 and 480, one or more rod bends 475 may be incorporated. As shown in FIG. 6, the one or more application rod bends 475 may be any angle between 0 degrees and 90 degrees to allow for easier access to the various locations of drain holes 210. It is important to note that the one or more rod bends 475 should be smooth so as not to hamper the flow of fluid between application rod sections 470 and 480. Rod bends 475 may include a connector section to allow for the coupling of two different length sections 470 and 480 or two different materials being coupled together. Further, application rod sections 470 and 480 may be of various constructions, for example, application rod sections 470 and 480 may be constructed of rigid, flexible or semi-rigid materials or any combination thereof. For example, application rod section 470 may be of a rigid construction and application rod section 480 may be of a flexible constriction and the two sections may be connected at rod bend 475.

As shown in FIG. 4, reducer 435 may be used to further add pressure to the fluid within include cleaning fluid holder 410. Reducer 435 may incorporate male and female threads to allow for the connection to cleaning fluid holder 410 and application rod 470. One skilled in the art will appreciate that many means of connection between cleaning fluid holder 410 and application rod 470 may be used. For example, other than using a threaded connection, a one-piece construction, an adhesive or any other suitable means for connecting cleaning fluid holder 410 and application rod 470 may be used.

As shown in FIG. 7, further disclosed is a method 700 for cleaning a sunroof drain comprising the steps of step 710 locating one or more sunroof drains; Step 720 removing any large debris from the drain opening; Step 730 filling a sunroof drain injector with solvent to unclog the drain; Step 740 pressurizing the solvent within the injector; Step 750 applying the pressurized solvent into the sunroof drain; and Step 760 optionally pouring water into the drain to test that the clog has been removed. The cycle may be repeated from Step 730 if necessary.

Aspects of the present disclosure have been described in detail with reference to the illustrated embodiments; those skilled in the art will recognize, however, that many modifications may be made thereto without departing from the scope of the present disclosure. The present disclosure is not limited to the precise construction and compositions disclosed herein; any and all modifications, changes, and recognizable variations apparent from the foregoing descriptions are within the scope of the disclosure as defined by the appended claims. Moreover, the present concepts expressly include any and all combinations and subcombinations of the preceding elements and features.

1. A sunroof drain cleaning apparatus comprising:
an injector for providing pressurized cleaning solvent to a tube;
a means for providing localized and pressurized cleaning solvent to a drain; and
a means for placing said cleaning fluid under pressure.

2. Apparatus as set forth in claim 1, wherein said means for injecting further comprises a tube for delivering said cleaning fluid into said drain.

3. Apparatus as set forth in claim 2 wherein said cleaning fluid is a solvent.

4. A method for cleaning a sunroof drain comprising the steps of:
utilizing a cleaning fluid for cleaning said sunroof drain; and
manually injecting said cleaning fluid into said sunroof drain using a hand operated compressible cylinder which provides tactile feedback to an operator regarding pressure required to deliver said cleaning fluid and effectuate the cleaning.

5. A method as set forth in claim 4, wherein said cleaning fluid is a solvent.

6. A method as set forth in claim 4, wherein said step of injecting further comprises the step of utilizing a tube for delivering said cleaning fluid into said drain.

7. (canceled)

8. A sunroof drain cleaning apparatus comprising:
an injector for providing pressurized cleaning fluid to a tube; and
a tube for providing localized and pressurized cleaning fluid to said sunroof drain.

9. Apparatus as set forth in claim 8, further comprising means for pressurizing the cleaning fluid.

10. Apparatus as set forth in claim 9, wherein said cleaning fluid is a solvent.

11. A method for cleaning a sunroof drain comprising the steps of:
providing cleaning fluid to said sunroof drain; and
manually pressurizing said cleaning fluid using a hand operated compressible cylinder which provides tactile feedback to an operator regarding pressure required to deliver said cleaning fluid and effectuate the cleaning.

12. A method as set forth in claim 11, wherein said step of providing further comprises the step of utilizing a tube to deliver cleaning fluid locally to said sunroof drain.

13. A method as set forth in claim 12, wherein utilizing a tube to deliver cleaning fluid locally to said sunroof drain includes using a substantially unbendable tube.

14. A method as set forth in claim 12, wherein utilizing a tube to deliver cleaning fluid locally to said sunroof drain includes using a bendable tube.

15. A method for cleaning a sunroof drain comprising:
locating one or more sunroof drains;
filling a sunroof drain injector with cleaning fluid to unclog the drain; wherein said cleaning fluid is a solvent, and
manually pressurizing said cleaning fluid using a hand operated compressible cylinder associated with the injector which provides tactile feedback to an operator regarding pressure required to deliver said cleaning fluid and effectuate cleaning.

16. (canceled)
